(19) United States
(12) Patent Application Publication
(10) Pub. No.: US 2007/0164685 A1
(43) Pub. Date: Jul. 19, 2007

(54) Discharge lamp lighting apparatus

(75) Inventors: Yuji Hase, Tokyo (JP); Akihiko Iwata, Tokyo (JP); Shigeki Harada, Tokyo (JP); Kikuo Izumi, Tokyo (JP); Takashi Ohsawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 10/589,266

(22) PCT Filed: Apr. 6, 2005
(86) PCT No.: PCT/JP05/06782

§ 371 Date: Aug. 14, 2006

(30) Foreign Application Priority Data
Apr. 7, 2004 (JP) 2004-113336

(51) Int. Cl. H05B 41/16

(52) U.S. Cl. 315/274

(57) ABSTRACT

A discharge lamp lighting apparatus includes: a DC power supply to supply power to a HID lamp; a transformer to transmit a voltage of DC power supply to the HID lamp; a switch connected between the DC power supply and a primary winding of the transformer; switches connected to a primary side of the transformer; an inductance connected in series to a secondary winding of the transformer; a series resonance circuit connected to a secondary side of the transformer and including an inductance and a capacitor; and a parallel resonance circuit connected to the secondary side of the transformer and including an inductance and a capacitor. The switches are opened or closed to intermittently supply power from the DC power source to the transformer to always supply a current to the transformer.

### TECHNICAL FIELD

The present invention relates to a discharge lamp lighting apparatus.

### BACKGROUND ART

In recent years, high intensity discharge lamps (hereinafter referred to as “HID”) have been spread out as the headlights of automobiles. The HID lamp has a brightness of 3200 lm which is 2 times as high as a halogen lamp conventionally used, a working power of 35 W which is a half as small as the halogen lamp, and a life of 2000 hours which is several times as long as the halogen lamp.

There has been, for example, a discharge lamp lighting apparatus disclosed in patent document 1 as a circuit for lighting a vehicle-mounted headlight using a conventional HID lamp. In this discharge lamp lighting apparatus, a direct current (DC) voltage supplied from the battery of automobile is boosted by a DC-DC booster circuit, converted to an alternating current of a low frequency of approximately 400 Hz, and supplied to the HID lamp. In this manner, in the discharge lamp lighting apparatus disclosed in patent document 1, power is supplied to the HID lamp in two steps.

The HID lamp is lit at the start thereof by applying thereto a high voltage pulse of approximately 20 kV. In order to generate such a high voltage pulse of approximately 20 kV, it is indispensable for a conventional HID lamp lighting apparatus to include an ignition part having an igniter transformer and a gap switch. However, this igniter transformer is large in size and also high in cost, which becomes a major cause of hindering downsizing and lowered cost of the HID lamp lighting apparatus.

Moreover, when the HID lamp is driven at a high frequency to be lit, at the time of discharge growth and steady lighting, a large loss of power is caused by the inductance component (approximately 1 mH) of the igniter transformer, which becomes a factor in reduction of efficiency.

[Patent document 1] JP-A-2002-352989

An apparatus for lighting the headlight of automobile is required to be further reduced in size and cost. It is thought as a method of realizing this that an igniter transformer is removed from the HID lamp lighting apparatus. If the igniter transformer can be removed from the HID lamp lighting apparatus, the HID lamp lighting apparatus can be actually reduced in size and cost. Moreover, in this case, a power loss caused by the inductance component of igniter transformer can be eliminated.

However, even if the igniter transformer is removed, a circuit configuration suitable for the discharge characteristics of HID lamp as shown below needs to be realized.

In the HID lamp, the load resistance of HID lamp is different according to its operating state and hence power required of the HID lighting apparatus is also different in accordance with the load resistance.

Further, in the cold start of starting to light the HID lamp in a state where the HID lamp is cold because a long time passes after the HID lamp is put out, the resistance of HID lamp is as small as approximately several tens Ω, whereas in the hot start of starting to light the HID lamp again in a state where the HID lamp is yet hot because only a short time passes after the HID lamp is put out, the resistance of HID lamp is high. For this reason, power supply conditions required to start up luminous flux after starting to light the HID lamp are different between the hot start and the cold start.

Still further, a power of 35 W at the time of steadily lighting the HID lamp is required to be supplied with efficiency.

This invention has been made to solve the above-described problems. The object of this invention is to provide a discharge lamp lighting apparatus capable of supplying power in a manner suitable for the discharge characteristics of a high intensity discharge lamp with a high degree of efficiency without employing an igniter transformer.

### DISCLOSURE OF THE INVENTION

A discharge lamp lighting apparatus in accordance with this invention includes: a DC power supply for supplying power to a discharge lamp; a transformer for transmitting a voltage of the DC power supply to the discharge lamp; a power supply switching element connected between the DC power supply and a primary winding of the transformer; and a first switching element and a second switching element that are connected to a primary side of the transformer, and opens or closes the power supply switching element, the first switching element, and the second switching element to intermittently supply power from the DC power source to the transformer, thereby circulating a current through the primary side of the transformer even when the power is not supplied to the transformer.

According to this invention, even when the power is not supplied from the DC power supply, it is possible to reduce the number of switchings and hence to reduce a loss and to enhance the efficiency of power supply to the discharge lamp by circulating a current on the primary side of transformer.

### BRIEF DESCRIPTION OF THE DRAWINGS

FIG. 1 is a circuit diagram showing the configuration of a high intensity discharge lamp lighting apparatus in accordance with embodiment 1 of this invention.

FIG. 2 is diagrams each showing the relationship between a gate signal applied to each switch and the temporal waveform of a current passing through the switch in accordance with embodiment 1 of this invention.

FIG. 3 is diagrams each showing a current path when a gate signal applied to each switch is changed in accordance with embodiment 1 of this invention.

FIG. 4 is diagrams each showing the temporal waveform of a current passing through each element in accordance with embodiment 1 of this invention.

FIG. 5 is diagrams each showing the waveform of a current passing through each switch in accordance with embodiment 1 of this invention.

FIG. 6 is a flow chart of an operating procedure from the startup of HID lamp to the steady lighting of it in accordance with embodiment 1 of this invention.

FIG. 7 is diagrams each describing the control of supply of a current from a DC power in accordance with embodiment 2 of this invention.

FIG. 8 is diagrams each describing the control of supply of a current from a DC power in accordance with embodiment 3 of this invention.

FIG. 9 is diagrams each describing the control of supply of a current from a DC power in accordance with embodiment 3 of this invention.

FIG. 10 is diagrams each showing the configuration of inductors of a high intensity discharge lamp lighting apparatus in accordance with embodiment 4 of this invention.

FIG. 11 is diagrams each showing the configuration of inductors of a high intensity discharge lamp lighting apparatus in accordance with embodiment 4 of this invention.

FIG. 12 is diagrams each showing the relationship between the level of a current passing through a capacitor and a current passing through a HID lamp in accordance with embodiment 5 of this invention.

### BEST MODE FOR CARRYING OUT THE INVENTION

Hereinafter, in order to describe this invention in more detail, the best mode for carrying out this invention will be described in accordance with the accompanying drawings.

### EMBODIMENT 1.

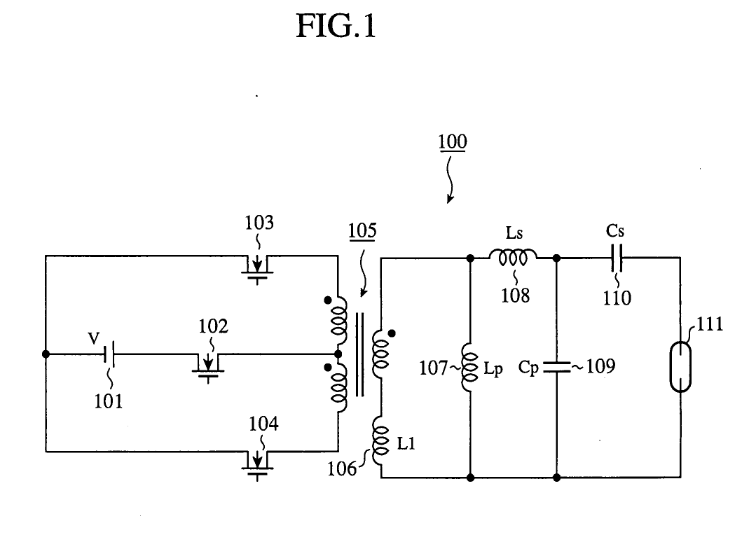

FIG. 1 is a circuit diagram showing the configuration of a high intensity discharge lamp lighting apparatus 100 in accordance with embodiment 1 of this invention.

As shown in the drawing, the high intensity discharge lamp lighting apparatus 100 includes a DC power supply 101, a switch (power supply switching element) 102, a switch (first switching element) 103, a switch (second switching element) 104, a transformer 105, an inductor (first inductance element) 106, an inductor (third inductance element) 107, an inductor (second inductance element) 108, a capacitor (first capacitor) 109, a capacitor (second capacitor) 110, and a HID lamp (discharge lamp) 111.

Further, assume that the voltage of DC power supply 101 is V, the inductance of inductor 106 is L1, the inductance of the inductor 107 is Lp, the inductance of the inductor 108 is Ls, the capacity of the capacitor 109 is Cp, and the capacity of the capacitor 110 is Cs.

The switch 102 is interposed between the DC power supply 101 and a primary winding of the transformer 105 and becomes a switch for supplying power to the transformer 105. The switch 103 and switch 104 are provided on a primary side of the transformer 105.

The inductor 106 is connected in series to a secondary winding of the transformer 105, and the inductor 107 is connected in parallel to the secondary winding of the transformer 105. The inductor 108, capacitor 109, and capacitor 110 are connected between the secondary winding of the transformer 105 and the HID lamp 111.

In this regard, in embodiment 1, a DC voltage is applied to the HID lamp 111 to start up the HID 111, but a section for applying the DC voltage to the HID lamp 111 is not shown in the drawing.

Semiconductor power devices for use in power such as MOSFET, power transistor, and IGBT can be used as the switches 102, 103, and 104. Alternatively, semiconductor power devices for use in power made of a wide gap semiconductor such as SiC and GaN may be used.

The transformer 105 is a push-pull transformer in which the center of the primary winding is connected to the DC power supply 101 via the switch 102. The turns ratio between the primary winding and the secondary winding of the transformer 105 is set at a value capable of supplying a predetermined power even when the impedance of HID lamp 111 becomes high. Specifically, for example, the turns ratio is set at a value capable of providing a voltage required of the secondary winding of the transformer 105 when the voltage of the DC power supply 101 is decreased. Here, the turns ratio is approximately 1:1:17, but the turns ratio is not limited to this value.

On the secondary side of the transformer 105, a series resonance circuit is constructed of the inductor 108 and the capacitor 110 so as to supply power suitable for the load of HID lamp 111 with efficiency and a parallel resonance circuit is constructed of the inductor 107 and the capacitor 109.

Next, the operation will be described below.

The HID lamp 111 has four operating states of (A) discharge standby, (B) startup of discharge, (C) transient discharge, and (D) steady discharge. Since the load resistances of HID lamp 111 in the four operating states are different from each other, power needs to be supplied with efficiency in accordance with the operating states. Hereinafter, a brief description of (B) startup of discharge, (C) transient discharge, and (D) steady discharge will be given.

(B) Startup of Discharge

When a DC voltage of approximately 10 kV is applied to the HID 111, the HID lamp 111 is dielectrically broken down to start the discharge. Here, the discharge is started by this DC voltage. A conventional discharge lighting apparatus starts to light a HID lamp when an impulse voltage of approximately 20 kV is applied thereto and hence needs to have an igniter transformer for generating this impulse voltage.

(C) Transient Discharge

The transient discharge is such that develops during a time period from the startup of the discharge to the steady discharge in which metal halogenide in the HID lamp 111 discharges with stability. For the HID lamp 111 to keep discharging during the time period of the transient discharge and to start up luminous flux quickly, the HID lamp 111 needs to be supplied with a sufficient amount of power. In particular, when the HID lamp 111 is applied to the vehicle-mounted headlight, the luminous flux needs to be started up within a few seconds after the startup of lighting.

Depending on the length of time that passes after the HID lamp 111 is put out, the resistance of the HID lamp 111 immediately after the startup of discharge is different and hence power required to be supplied is different. A case of starting to light the HID lamp 111 after it is put out and then a short time passes is called a hot start and the resistance of HID lamp 111 immediately after starting to light the HID lamp 111 is several hundreds Ω. On the other hand, a case of starting to light the HID lamp 111 after it is put out and a long time passes is called a cold start and the resistance of HID lamp 111 immediately after starting to light the HID lamp 111 is several tens Ω, which is a low value.

(D) Steady Discharge

The steady discharge is a state where stable discharge develops in the HID lamp 111 and a constant power needs to be supplied to the HID lamp 111 during this time period. In embodiment 1, power to be supplied to the HID lamp 111 during the steady discharge is 35 W.

In the state of steady discharge, the high intensity discharge lamp lighting apparatus 100 performs a high frequency lighting operation in which a driving frequency is several tens kHz. When the HID lamp 111 is lit at a high frequency, arc in the HID lamp 111 is made unstable by an acoustic resonance phenomenon to cause the HID lamp 111 to flicker or to go out. In order to prevent this, the driving frequency of power to be supplied at a high frequency is fluctuated. With this, the HID lamp 111 can be lit even in the driving frequency of several tens kHz.

Next, power supply during the time period of transient discharge when the high intensity discharge lamp lighting apparatus 100 is cold-started in accordance with embodiment 1 will be described.

In order to supply power to the load with efficiency, a switching loss and a conduction loss of the switch need to be reduced on the primary side of the transformer 105.

Specifically, first, the switch 102 is turned on. At this time, either the switch 103 or switch 104 is turned on to supply power from the DC power supply 101. After the switch 102 is on for a predetermined time, the switch 102 is turned off. Thereafter, the switch 103 and switch 104 are turned on at the same time to keep passing a current through the primary circuit of the transformer 105 through the primary winding of the transformer 105, the switch 103, and the switch 104. At this time, on the secondary side of the transformer 105, a current is passed through all circuit sections including the inductors 106, 107, and 108, and the capacitors 109, 110, and the HID lamp 111.

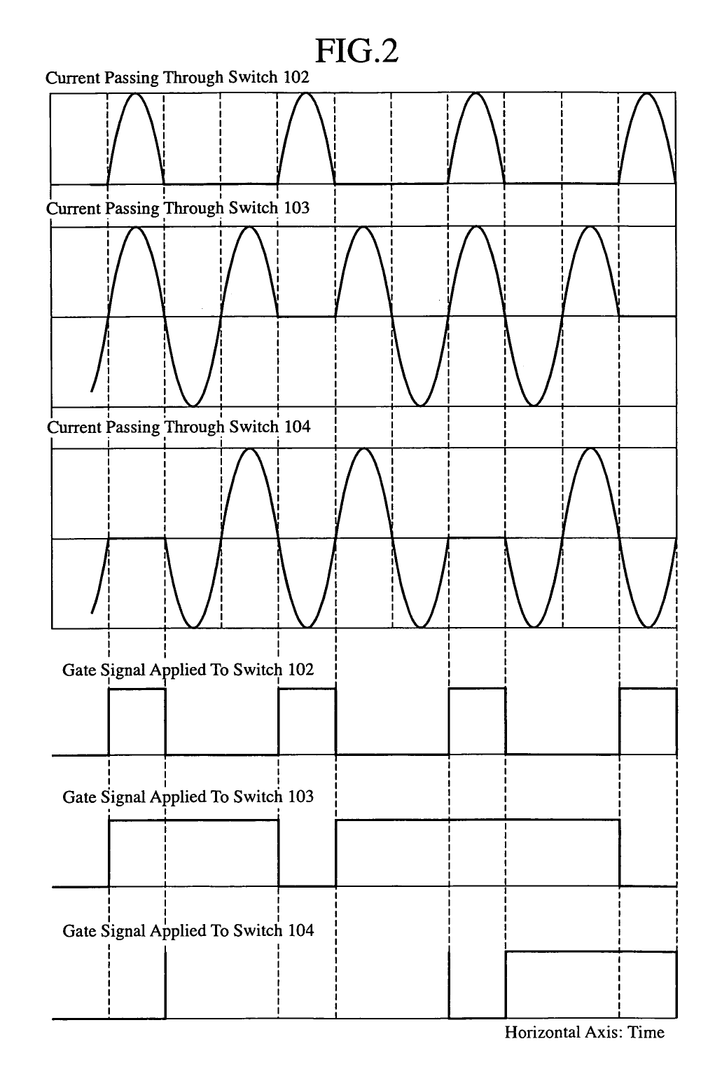

FIG. 2 is diagrams each showing the relationship between a gate signal applied to each switch of the primary circuit of the transformer 105 and the temporal waveform of a current passing through each switch.

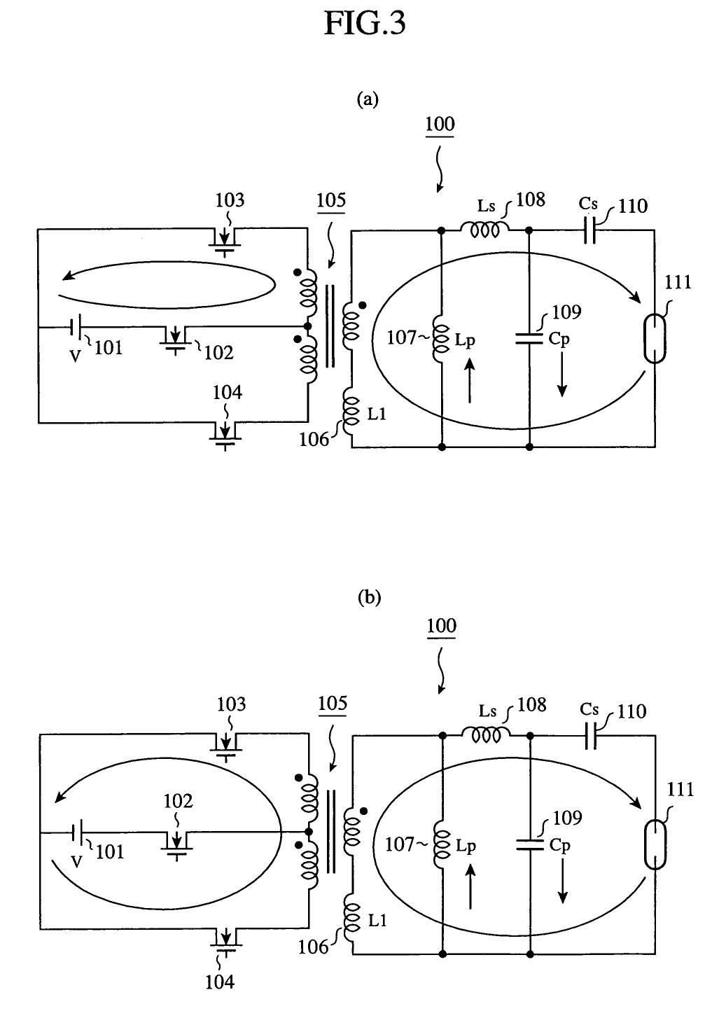

Moreover, FIG. 3 is diagrams each showing a current path when the gate signal applied to each switch is changed.

As shown in FIG. 2, first, when the gate signals applied to the switches 102 and 103 are turned on, a current is passed through the switches 102 and 103 and is not passed through the switch 104 (FIG. 3(a)). Then, when the gate signal applied to the switch 102 is turned off and the gate signals applied to the switches 103 and 104 are turned on, a current is passed through the switches 103 and 104 and is not passed through the switch 102 (FIG. 3(b)). After one period, this time, the gate signals applied to the switches 102 and 104 are turned on and the gate signal applied to the switch 104 is turned off. At this time, a current is passed through the switches 102 and 104 and is not passed through the switch 103. Thereafter, the gate signal applied to the switch 102 is turned off and the gate signals applied to the switches 103 and 104 are turned on, a current is passed through the switches 103 and 104 and is not passed through the switch 102.

By repeatedly performing the above operations, it is possible to supply power from the DC power supply 101 intermittently and to keep supplying power to the secondary circuit of the transformer 105.

According to this method, it is possible to realize power supply of high degree of efficiency at the time of low load when the HID lamp 111 is lit in the state of cold start.

That is, when the gate signal applied to the switch 102 is turned off, power from the power supply is not supplied and hence power supply of high degree of efficiency can be realized.

Moreover, when the gate signal applied to the switch 102 is turned off, a current passing through the primary side of the transformer 105 is decreased and hence a conduction loss is decreased. In addition,since there is a time period during which a current is circulated through the switch 103 and switch 104, the number of switchings of the switches 102, 103, and 104 are decreased and hence a switching loss is decreased.

Specifically, in embodiment 1, a power of approximately 70 W is supplied to the HID lamp 111 during the time period of transient discharge at the time of cold start to keep discharging to thereby start up luminous flux quickly.

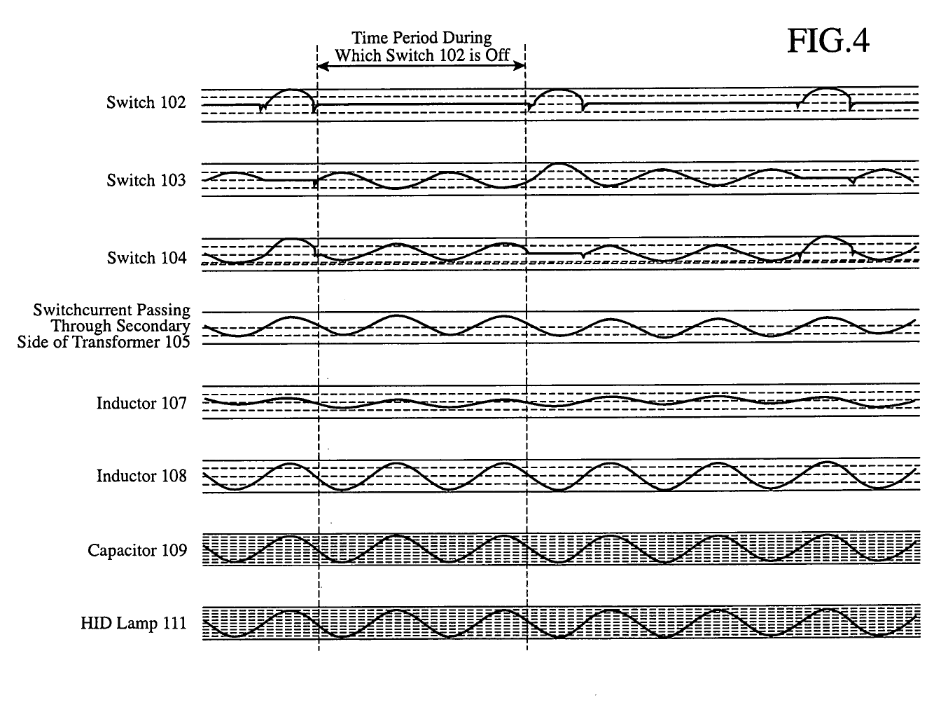

FIG. 4 is diagrams each showing the temporal waveform of a current passing through each element. As shown in the drawing, a current is passed through the respective elements even in a time period during which the gate signal applied to the switch 102 is off.

The substantial turns ratio between the primary winding and the secondary winding of the transformer 105 varies between the case where the gate signal applied to the switch 102 is on and the case where the gate signal is off. When the gate signal applied to the switch 102 is off, a primary effective current becomes small with respect to a secondary current and hence a current passing through the switches 103 and 104 becomes small and hence a power loss on the primary side can be reduced.

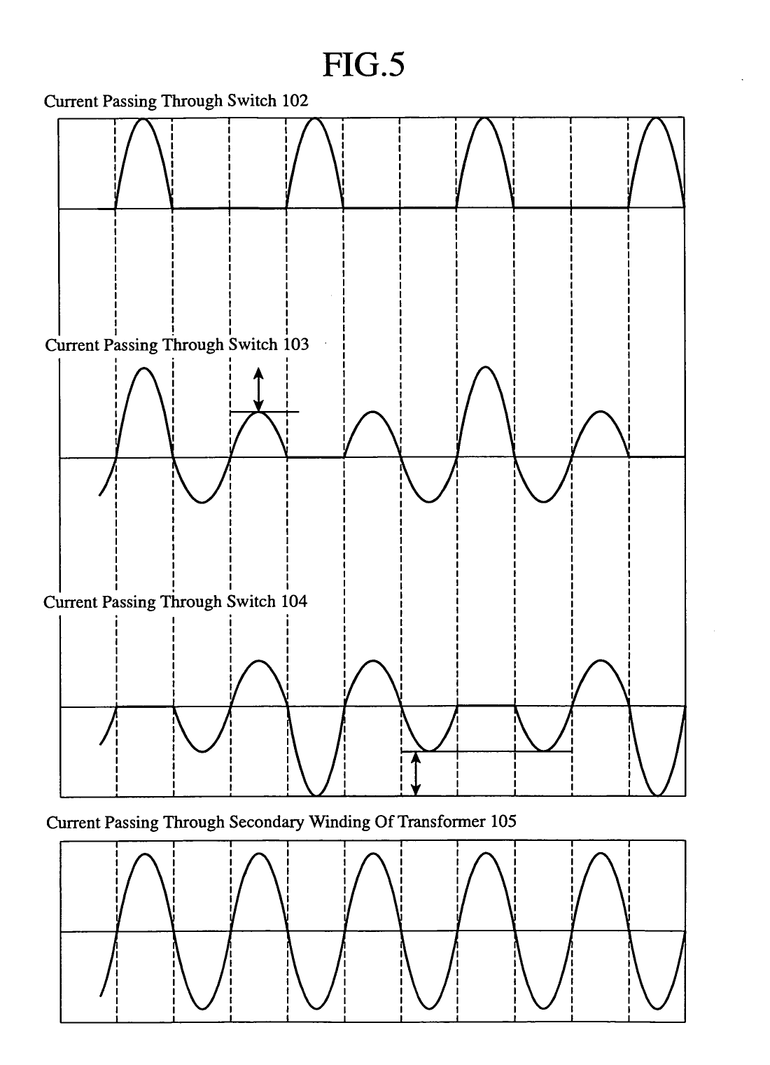

Moreover, FIG. 5 is diagrams each showing the waveform of a current passing through each switch. As shown in FIG. 4 and FIG. 5, a peak value of current passing through the switch 103 or the switch 104 varies between the case where the gate signal applied to the switch 102 is on and the case where the gate signal is off. In this regard, the power loss on the primary side includes, for example, the conduction losses of the switching elements, and the like.

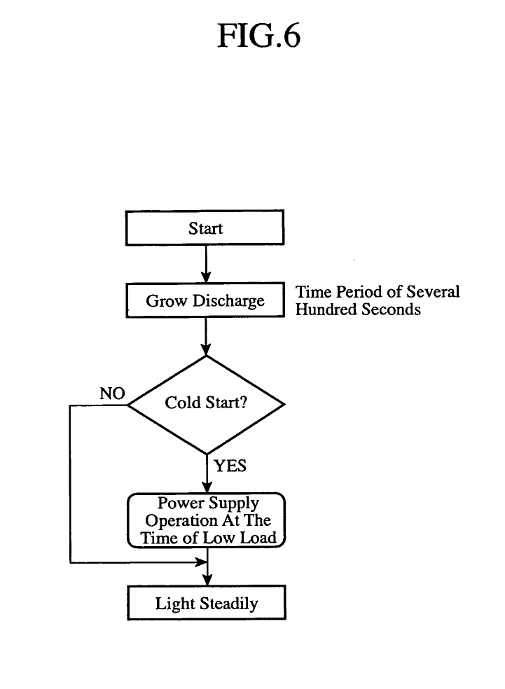

FIG. 6 is a flow chart of an operating procedure from the startup of the HID lamp 111 to the steady lighting of it. A time period of several hundreds microseconds after the DC voltage being applied to the HID lamp 111 to start lighting the HID lamp 111 is a time period of growing a discharge in which a larger amount of power needs to be supplied to the HID lamp 111. During this time period, it is determined whether or not the state of HID lamp 111 corresponds to a cold start. Specifically, when it is determined that the impedance of HID lamp 111 is low, the operation is shifted to the above-described power supply operation at the time of low load and then shifted to the steady state.

With this, the efficiency of power supply at the time of cold start can be enhanced.

Moreover, in embodiment 1, in order to enhance the efficiency of power supply at the time of steady discharge, a resonance circuit including the capacitor and the inductor is provided on the secondary side of the transformer 105 and the values of elements are set in such a way that the resonance circuit has a resonance frequency close to the central frequency of a varying driving frequency. Here, the values of respective elements are set at Cs=3 nF, Cp=3 nF, Ls=0.3 mH, and Lp =0.25 mH.

However, the values of the respective elements may be set at other ones if the resonance frequency is a value capable of responding to the driving frequency of power to be supplied to the HID lamp 111.

In addition, the inductor 106 is connected in series to the secondary winding of transformer 105. With this, the efficiency of power supply at the time of cold start can be enhanced. Here, it is assumed that L1=0.1 mH.

As described above, according to embodiment 1, in the high intensity discharge lamp lighting apparatus 100 in which a long time passes after the HID lamp 111 is put out, it is possible to supply power to the HID lamp 111 with efficiency during the time period of transient discharge after starting to light the HID lamp 111. Moreover, since the DC voltage is applied to the HID lamp 111 to be started, the igniter transformer for generating a short pulse required to start the conventional HID lamp 111 is removed. Therefore, the high intensity discharge lamp lighting apparatus 100 can be reduced in size.

### EMBODIMENT 2.

In embodiment 2, a desired power is supplied to the HID lamp 111 by determining timings when the switch 102 is turned on and off on the basis of the period of current passing through the secondary winding of the transformer 105.

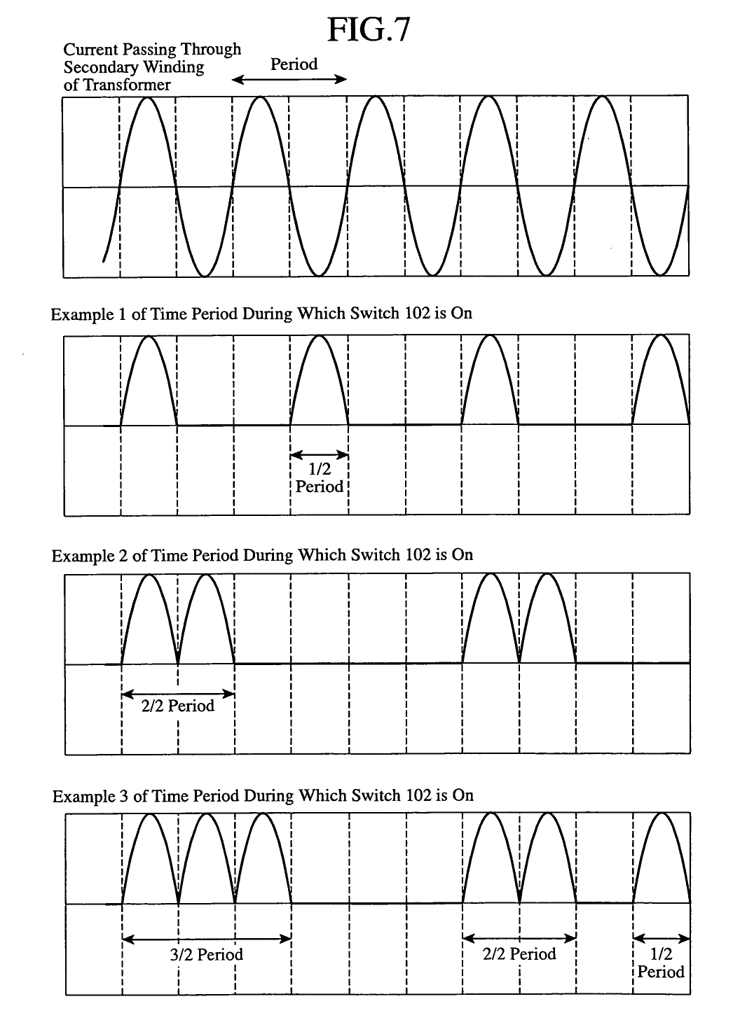

FIG. 7 is diagrams describing the control of supply of current from the DC power supply 101 in accordance with embodiment 2.

Here, a time period during which the switch 102 is on is N/2 times an oscillation period (where N is a natural number) with respect to the period of current passing through the secondary winding of the transformer 105. For example, in example 1, a time period during which the switch 102 is on is 1/2 times the oscillation period and a time period during which the switch 102 is off is 2/2 times the oscillation period. In example 2, a time period during which the switch 102 is on is 2/2 times the oscillation period and a time period during which the switch 102 is off is 4/2 times the oscillation period. In example 3, a time period during which the switch 102 is on varies 3/2 times, 2/2 times, and 1/2 times the oscillation period, whereas a time period during which the switch 102 is off varies 3/2 times and 1/2 times the oscillation period. The control of turning on and off the switch 102 may be performed periodically at the same timings as shown in the examples 1 and 2. Alternatively, the switch 102 maybe turned on and off at different on timings and different off timings as shown in the example 3.

It is possible to prevent a current passing through the secondary winding of the transformer 105 from being reduced to zero when the switch 102 is off. Moreover, by setting a time period during which the switch 102 is off at N/2 times the oscillation period of current passing through the secondary winding of the transformer 105, a current when the switches 103 and 104 are turned off is reduced to zero and hence a switching loss is reduced, whereby the efficiency of power supply can be enhanced.

Moreover, it is also recommended that the length of time period during which the switch 102 is on be adjusted by a duty ratio with respect to N/2 times the oscillation period of current passing through the secondary winding of the transformer 105 to supply a desired power to the HID lamp 111.

As described above, according to embodiment 2, the time period during which the switch 102 is on is adjusted on the basis of the oscillation period of current passing through the secondary winding of the transformer 105. Therefore, when the HID lamp 111 in which a long time passes after it is put out is lit, it is possible to supply power to the HID lamp 111 with efficiency during the time period of transient discharge after starting to light the HID lamp 111.

### EMBODIMENT 3.

In embodiment 3, a desired power is supplied to the HID lamp 111 by determining timings when the switch 102 is turned on and off on the basis of the oscillation period of a current passing through the secondary winding of transformer 105.

At this time, a time period during which the switch 102 is off is N times the oscillation period of a current passing through the switches 103 and 104.

For example, in FIG. 2, the time period during which the switch 102 is on is 1/2 times the oscillation period of the current passing through the switches 103 and 104. Moreover, the time period during which the switch 102 is off is 1 times the oscillation period of a current passing through the switches 103 and 104.

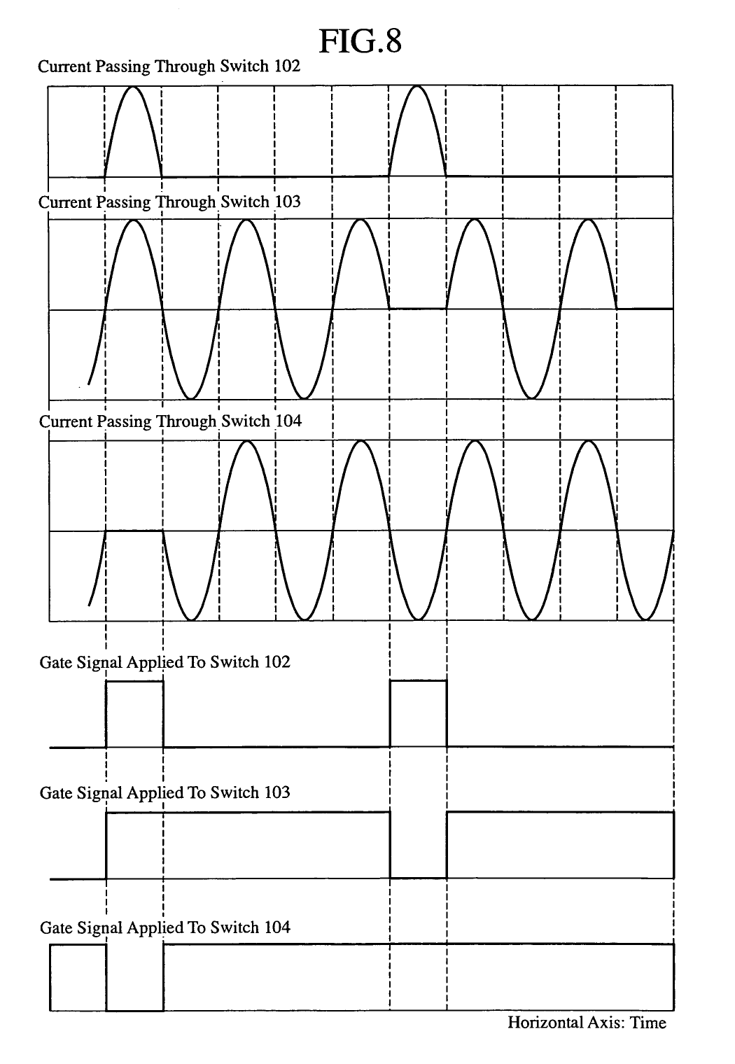

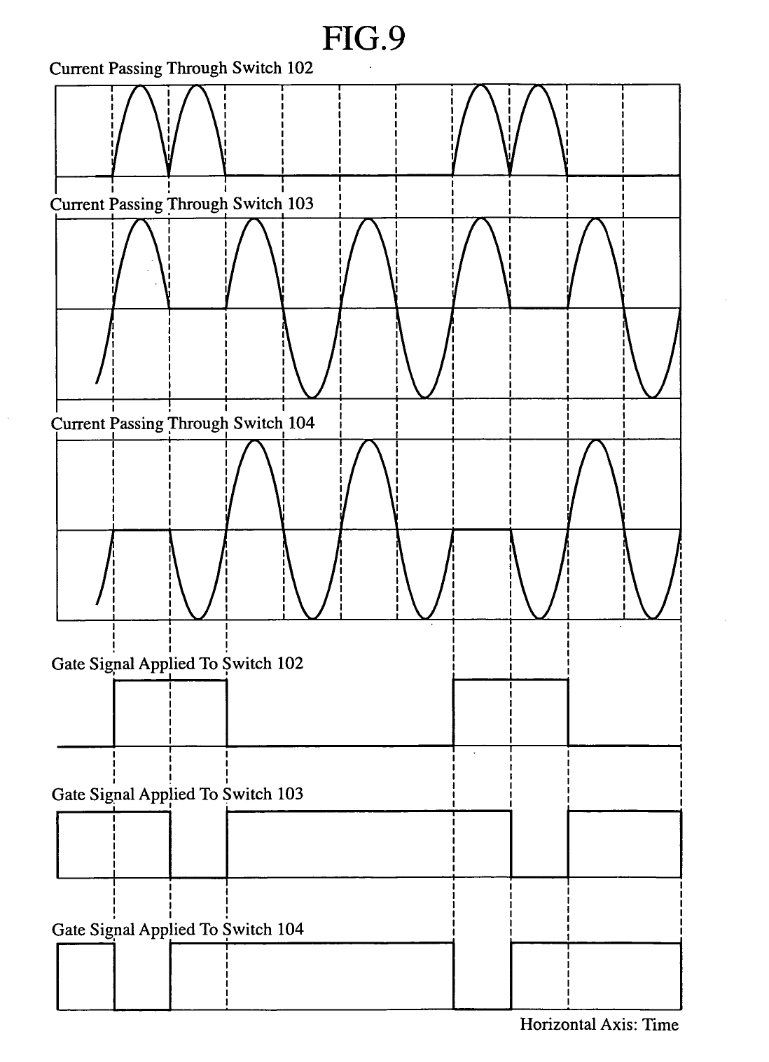

Further, in the example shown in FIG. 8, the time period during which the switch 102 is on is 1/2 times the oscillation period of the current passing through the switches 103 and 104, whereas the time period during which the switch 102 is off is 2 times the oscillation period of the current passing through the switches 103 and 104. In the example shown in FIG. 9, the time period during which the switch 102 is on is 2/2 times the oscillation period of the current passing through the switches 103 and 104, whereas the time period during which the switch 102 is off is 2 times the oscillation period of the current passing through the switches 103 and 104.

Still further, power supply can be performed with a higher degree of efficiency by varying the time period during which the switch 102 is on according to a load current or a load power on the secondary side of the transformer 105. At this time, it is also recommended that the duty ratio of time period during which the switch 102 is on be varied. Here, the control of turning on or off the switch 102 may be performed periodically at the same timings as shown in FIGS. 2, 8 and 9 or may be performed in a manner such that the switch 102 is turned on or off at different timings.

Still further, it is also recommended that the length of time period during which the switch 102 is on be adjusted by a duty ratio with respect to N/2 times the oscillation period of current passing through the switches 103 and 104 to supply a desired power to the HID lamp 111.

As described above, according to embodiment 3, the time period during which the switch 102 is on is adjusted on the basis of the oscillation period of the current passing through the switches 103 and 104. Therefore, when the HID lamp 111 in which a long time passes after it is put out is lit, it is possible to supply power to the HID lamp 111 with efficiency during the time period of transient discharge after starting to light the HID lamp 111.

### EMBODIMENT 4.

In embodiment 4, the configuration of the respective inductors constructing the secondary side of the transformer 105 is made more preferable.

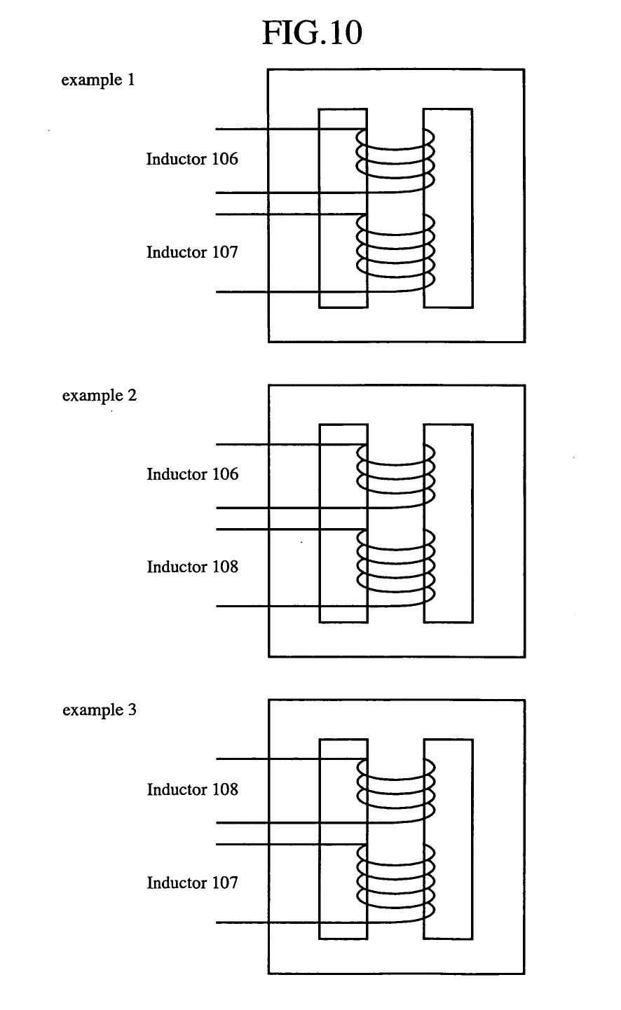

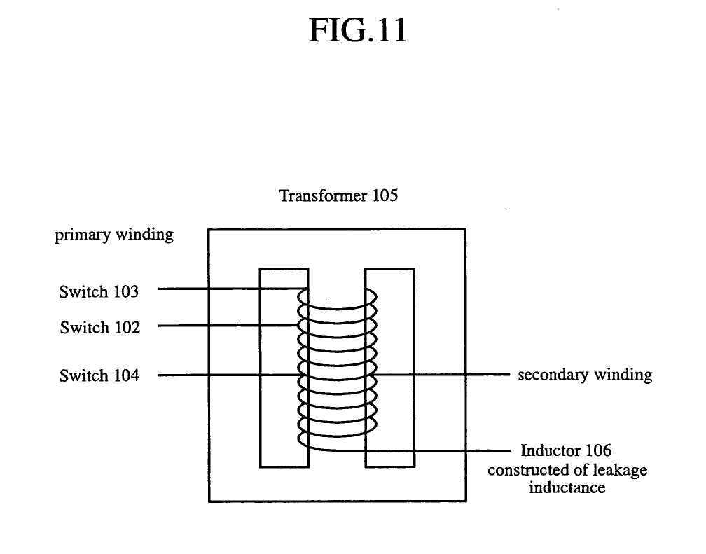

FIG. 10 and FIG. 11 are diagrams showing the configuration of the inductors of the high intensity discharge lamp lighting apparatus 100 in accordance with embodiment 4. In FIG. 10, any two of the inductors 106, 107, and 108 on the secondary side of the transformer 105 are formed of the same core. With this, the volume of high intensity discharge lamp lighting apparatus 100 can be reduced.

Moreover, in FIG. 11, the inductor 106 connected in series to the secondary winding of the transformer 105 is formed by utilizing the leakage inductor of secondary winding of the transformer 105. With this, the volume of high intensity discharge lamp lighting secondary 100 can be reduced.

As described above, according to embodiment 4, the high intensity discharge lamp lighting secondary 100 can be reduced in size by reducing the volumes of inductors on the secondary side of transformer 105.

### EMBODIMENT 5.

In embodiment 5, the capacity Cp of the capacitor 109 and the capacity Cs of the capacitor 110 are made more preferable values.

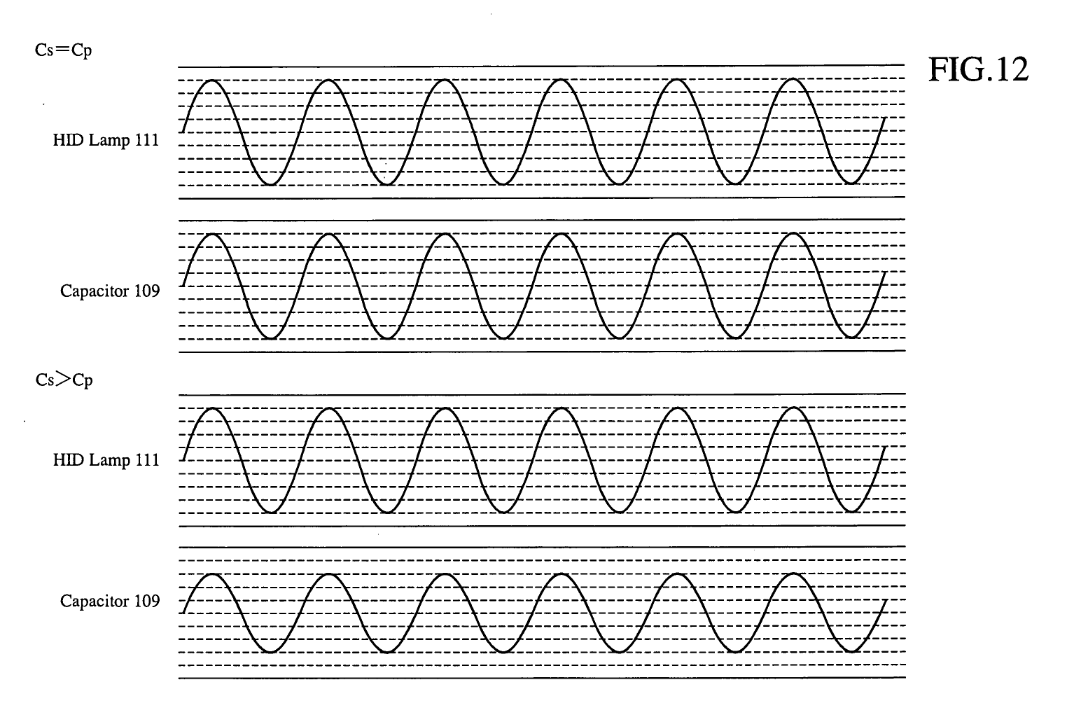

In FIG. 12 is shown the relationship between the values of Cp and Cs and a current passing through the HID lamp 111 and a current passing through the capacitor 109. As shown in the drawing, when the values of Cp and Cs are equal to each other, a current passing through the HID lamp 111 is equal to a current passing through the capacitor 109. Moreover, when Cs is larger than Cp, the current passing through the HID lamp 111 is larger than the current passing through the capacitor 109. That is, by making Cs a value larger than Cp, a larger amount of current is passed through the HID lamp 111 and hence a larger amount of power can be supplied to the HID lamp 111.

As described above, according to embodiment 5, it is possible to enhance the efficiency of power supply to the HID lamp 111 by making the capacity Cs of the capacitor 110 a value larger than the capacity Cp of the capacitor 109.

### INDUSTRIAL APPLICABILITY

As described above, the discharge lamp lighting apparatus in accordance with this invention is suitable for using for vehicle-mounted headlights and the like.

1-10. (canceled)

11. A discharge lamp lighting apparatus comprising:
a DC power supply for supplying power to a discharge lamp;
a conversion circuit, including a switching element, for converting the voltage of the DC power supply into a high frequency; and
an LC resonance circuit between the discharge lamp and the conversion circuit;
wherein by opening and closing operations of the switching element, power supply from the DC power supply to the discharge lamp is intermittently performed, and wherein when the power is not supplied from the DC power supply, a resonance current passing through the resonance circuit is circulated through the switching element.

12. The discharge lamp lighting apparatus according to claim 11, wherein the conversion circuit includes: a transformer; a power supply switching element connected between the DC power supply and a primary winding of the transformer; and first and second switching elements that are connected to a primary side of the transformer,
wherein the resonance current passing through the LC resonance circuit is circulated through the transformer on the primary side of the transformer.

13. The discharge lamp lighting apparatus according to claim 12, wherein ON/OFF timings of the power supply switching element are determined on the basis of a period of a current passing through a secondary winding of the transformer.

14. The discharge lamp lighting apparatus according to claim 13, wherein ON/OFF operations of the power supply switching element are performed by a time period that is N/2 times a period (where N is a natural number) of a current passing through a secondary winding of the transformer.

15. The discharge lamp lighting apparatus according to claim 12, wherein ON/OFF timings of the power supply switching element are determined on the basis of a period of a current passing through the first switching element and the second switching element.

16. The discharge lamp lighting apparatus according to claim 15, wherein ON/OFF operations of the power supply switching element are performed by a time period that is N/2 times a period (where N is a natural number) of a current passing through the first switching element and the second switching element.

17. The discharge lamp lighting apparatus according to claim 11, wherein power supply timings from the DC power supply to the discharge lamp are determined on the basis of a period of a load current.

18. The discharge lamp lighting apparatus according to claim 11, wherein an operation performing intermittently the power supply is performed at the time of the cold start of the discharge lamp.

19. The discharge lamp lighting apparatus according to claim 11, wherein an operation performing intermittently the power supply is performed when the impedance of the discharge lamp is low.

20. The discharge lamp lighting apparatus according to claim 12, wherein the LC resonance circuit includes:
a first inductance element connected in series to a secondary winding of the transformer;
a series resonance circuit connected to a secondary side of the transformer and including a second inductance element and a first capacitor; and
a parallel resonance circuit connected to the secondary side of the transformer, and including a third inductance element and a second capacitor.

21. The discharge lamp lighting apparatus according to claim 12, wherein the inductance used in the LC resonance circuit is formed of a leakage inductance of the secondary winding of the transformer.

22. A discharge lamp lighting apparatus comprising:
a DC power supply for supplying power to a discharge lamp;
a transformer for transmitting a voltage of the DC power supply to the discharge lamp;
a power supply switching element connected between the DC power supply and a primary side of the transformer; and
a first switching element and a second switching element that are connected to the primary side of the transformer,
wherein there are provided; a term to supply power from the DC power supply when the power supply switching element is turned on, and either the first switching element or the second switching element is turned on; and a term to pass a current through the primary side of the transformer when the power supply switching element is turned off, and the first switching element and the second switching element are turned on at the same time,
whereby power is intermittently supplied from the DC power supply to the transformer, and when power is not supplied from the DC power supply to the transformer, a current passing through the primary side of the transformer is circulated.

23. The discharge lamp lighting apparatus according to claim 11, wherein the discharge lump is a high intensity discharge lamp.

24. The discharge lamp lighting apparatus according to claim 22, wherein the discharge lump is a high intensity discharge lamp.
